(19) United States
(12) Patent Application Publication
(10) Pub. No.: US 2021/0141849 A1
(43) Pub. Date: May 13, 2021

(54) PAID INTERACTION METHOD AND SYSTEM FOR PRECISE SEARCH, TERMINAL AND STORAGE MEDIUM

(71) Applicant: GUANGZHOU EACHMAX TECHNOLOGY CO., LTD., Guangzhou (CN)

(72) Inventor: Xiwei Tang, Guangzhou (CN)

(21) Appl. No.: 17/087,567

(22) Filed: Nov. 2, 2020

(30) Foreign Application Priority Data
Nov. 13, 2019 (CN) 201911111170.6

(51) Int. Cl. G06F 16/9535; G06Q 20/10

(52) U.S. Cl. CPC G06F 16/9535; G06Q 20/10

(57) ABSTRACT

Disclosed are a paid interaction method and system for precise search, a terminal, and a storage medium. The method includes: receiving demand information released by a first user terminal; sending the demand information to all user terminals that customize the keyword; receiving response information from at least one second user terminal, where the response information is reply information sent by the second user terminal to the first user terminal; receiving request information of the first user terminal for granting medals to the second user terminal; adding the medals to the selected second user terminal according to the request information for granting the medals; and deleting the demand information and the response information. The embodiments of the present invention can reduce redundant information, improve search efficiency, and implement precise release of demand information, so that demands of users match each other, thereby improving interaction efficiency.

### CROSS REFERENCE TO RELATED APPLICATIONS

The present application claims the benefit of Chinese Patent Application No. 201911111170.6 filed on Nov. 13, 2019, the contents of which are incorporated herein by reference in their entirety.

### TECHNICAL FIELD

The present invention relates to the field of computers, and in particular, to a paid interaction method and system for precise search, a terminal and a storage medium.

### BACKGROUND

Currently, all search engines allow Internet users to search and screen based on mass information crawling. Although the Internet users can obtain abundant search results, the search engines have the following defects:

(1) Mass information is searched, and the results are still mass information, which makes it difficult for the users to find actually what they wanted.

(2) The Internet is full of repeated information and spam information, and effective information only accounts for a small proportion. Therefore, the Internet cannot provide precise and effective information for the Internet users.

(3) The mass information and mass storage lead to a large amount of data to be processed, thus resulting in a low search speed and a waste of electricity, resources, manpower and materials, and the like.

### SUMMARY

To solve the problems above, an objective of the present invention is to provide a paid interaction method and system for precise search, a terminal and a storage medium, to reduce redundant information, improve search efficiency, and further implement precise release of demand information, so that demands of users match each other, thus improving interaction efficiency.

In a first aspect, the embodiments of the present invention provide a paid interaction method for precise search, including:

receiving demand information released by a first user terminal, where the demand information includes: a subject, a keyword, a main body, and a quantity of medals for rewarding;

sending the demand information to all user terminals that customize the keyword, where the user terminals that customize the keyword are second user terminals;

receiving response information from at least one of the second user terminals, where the response information is reply information sent by the second user terminal to the first user terminal;

receiving request information of the first user terminal for granting the medals to the second user terminal, where the request information for granting the medals includes the quantity of the medals;

adding the medals to the selected second user terminal according to the request information for granting the medals; and

deleting the demand information and the response information.

Further, the paid interaction method for precise search further includes:

rejecting demand information released next time by the first user terminal if the request information of the first user terminal for granting the medals to the second user terminal is not received within specific duration after the receipt of the response information from the at least one of the second user terminals.

Further, the demand information further includes:

release duration; and the demand information is deleted if no response information from at least one of the second user terminals is received within the release duration starting from the moment when the demand information is released.

Further, while the demand information released by the first user terminal is received, the method further includes:

receiving screening information sent by the first user terminal; and

screening user terminals that match the screening information after receiving the screening information sent by the first user terminal, where the screening information includes a push region.

In a second aspect, the embodiments of the present invention provide a paid interaction system for precise search, including:

a receiving module, configured to receive demand information released by a first user terminal, where the demand information includes: a subject, a keyword, a main body, and a quantity of medals for rewarding;

a sending module, configured to send the demand information to all user terminals that customize the keyword, where the user terminals that customize the keyword are second user terminals;

the receiving module being further configured to receive response information from at least one of the second user terminals, where the response information is reply information sent by the second user terminal to the first user terminal;

the receiving module being further configured to receive request information of the first user terminal for granting the medals to the second user terminal, where the request information for granting the medals includes the quantity of the medals;

an adding module, configured to add the medals to the selected second user terminal according to the request information for granting the medals; and

a deletion module, configured to delete the demand information and the response information.

Further, the paid interaction system for precise search further includes:

a rejection module, configured to reject demand information released next time by the first user terminal if the request information of the first user terminal for granting the medals to the second user terminal is not received within specific duration after the receipt of the response information from the at least one of the second user terminals.

Further, the demand information further includes:

release duration; and the demand information is deleted if no response information from at least one of the second user terminals is received within the release duration starting from the moment when the demand information is released.

In a third aspect, the embodiments of the present invention provide a non-transient computer readable storage medium, where the non-transient computer readable storage medium includes a stored computer program, and when being run, the computer program controls a device where the non-transient computer readable storage medium is located to execute the above paid interaction method for precise search.

In a fourth aspect, the embodiments of the present invention provide a terminal device, including a processor, a memory, and a computer program stored in the memory and configured to be executed by the processor, where the processor, when executing the computer program, implements the above paid interaction method for precise search.

In an embodiment of the present invention, after a user who answers a question is rewarded, question information of a user who asks the question and response information are deleted, to reduce the amount of stored data, thereby reducing redundant information and improving search efficiency.

In the embodiments of the present invention, after the interaction is finished, the released demand information and the response information are deleted automatically, to reduce redundant information, thereby improving a data processing speed, and further improving search efficiency. In the embodiment of the present invention, the demand information is only sent to user terminals that customize the same keyword, to release the demand information precisely, so that demands of users can match each other, and interaction efficiency is improved.

### BRIEF DESCRIPTION OF THE DRAWINGS

FIG. 1 is a schematic flowchart of a paid interaction method for precise search according to an embodiment of the present invention;

FIG. 2 is a schematic structural diagram of a paid interaction system for precise search according to an embodiment of the present invention; and

FIG. 3 is another schematic structural diagram of a paid interaction system for precise search according to an embodiment of the present invention.

### DETAILED DESCRIPTION

The following clearly and completely describes the technical solutions in the embodiments of the present invention with reference to accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

The terms “include” and “comprise” indicate the existence of the described feature, entity, step, operation, element and/or component, but do not exclude the existence or addition of one or more other features, entities, steps, operations, elements, components and/or a combination thereof.

The term “and/or” refers to one of or any combination or all possible combinations of more of items listed in association, and includes these combinations.

Referring to FIG. 1, FIG. 1 is a schematic flowchart of a paid interaction method for precise search according to a first embodiment of the present invention. The paid interaction method for precise search is performed by a paid interaction system for precise search, and includes at least steps S100 to S105.

S100: receive demand information released by a first user terminal, where the demand information includes: a subject, a keyword, a main body, and a quantity of medals for rewarding.

In the embodiment of the present invention, the keyword is selected by a user autonomously, and the medals need to be purchased with money.

S101: send the demand information to all user terminals that customize the keyword, where the user terminals that customize the keyword are second user terminals.

S102: receive response information from at least one of the second user terminals, where the response information is reply information sent by the second user terminal to the first user terminal.

In the embodiment of the present invention, the reply information sent by the second user terminal to the first user terminal refers to information about a reply made by a user of the second user terminal according to the demand released by a user of the first user terminal.

S103: receive request information of the first user terminal for granting the medals to the second user terminal, where the request information for granting the medals includes the quantity of the medals.

It should be noted that, a first user can obtain the most valuable information from a plurality of pieces of reply information provided by a plurality of second users, so that the medals are distributed to a second user who can provide valuable information.

S104: add the medals to the selected second user terminal according to the request information for granting the medals.

S105: delete the demand information and the response information.

It should be noted that, step S105 is performed after step S104, to ensure the integrity of the interaction. That is, the corresponding information cannot be deleted until the metal distribution is finished.

In the embodiment of the present invention, for ease of clear presentation of the interaction process, the expressions of “demand information released by the first user terminal” and “response information of the second user terminal” are used in the embodiment of the present invention. However, in the embodiment of the present invention, the first user terminal is not restricted to be the carrier that releases the demand information, and the second user terminal is not restricted to be the carrier of the reply information. In the embodiment of the present invention, the first user terminal may also serve as the carrier of the reply information, and the second user terminal may also serve as the carrier that releases the demand information.

In the embodiment of the present invention, after the interaction is finished, the released demand information and the response information are deleted automatically, to reduce redundant information, thereby improving a data processing speed, and further improving search efficiency. In the embodiment of the present invention, the demand information is only sent to user terminals that customize the same keyword, to release the demand information precisely, so that demands of users can match each other, and interaction efficiency is improved.

In a preferred embodiment, the paid interaction method for precise search further includes:

rejecting demand information released next time by the first user terminal if the request information of the first user terminal for granting the medals to the second user terminal is not received within specific duration after the receipt of the response information from the at least one of the second user terminals.

In the embodiment of the present invention, for a user who gets the reply but does not grant the medals to the replier, the next release request of the user is rejected, which can reduce the data amount and improve data processing efficiency on the one hand, and on the other hand, can ensure that the present method is implemented successfully.

In a preferred embodiment, the demand information further includes release duration; and the demand information is deleted if no response information from at least one of the second user terminals is received within the release duration starting from the moment when the demand information is released.

It should be noted that, the release duration is a default duration value of the system, or a duration value customized by the first user. For example, the duration value is “one month”, and if no response information from any second user is received within one month since the demand information is released by the first user, it is determined that the demand information is a valueless demand or an unsolvable demand, and the system performs a deletion action automatically and reminds the first user that the demand information is deleted. The first user may further refresh or re-release the demand information.

In this method, demand information that exceeds the time limit is deleted, to reduce redundant information, thereby improving the data processing speed and improving the search efficiency.

In a preferred embodiment, while the demand information released by the first user terminal is received, the method further includes:

receiving screening information sent by the first user terminal; and

screening user terminals that match the screening information after receiving the screening information sent by the first user terminal, where the screening information includes a push region.

In the embodiment of the present invention, the demand information can be released to corresponding clients more precisely according to the screening information, thereby improving the interaction efficiency.

To illustrate the method in all the foregoing embodiments of the present invention more clearly, an example is used for description.

User Kaici releases a demand by using a terminal APP (such as an APP named Happy Help) on a mobile phone terminal, where the demand includes the following content: subject: agents of anodized plates from Japan; keywords: Japan, anodized plate, nationwide; reward medals: 2; release duration: 3 days.

When receiving the demand information, a corresponding base station, server, or the like sends the demand information to terminal users who customize the keywords “Japan” and “anodized plate” and are located in the specified region.

When knowing the content of the demand through mobile phone terminals, other users reply to the demand information on the mobile phone terminals and request to send the reply information back to Kaici's mobile phone terminal. If Kaici receives a plurality of pieces of reply information, Kaici distributes 2 medals to one or two target user terminals through the mobile phone terminal according to the received reply information.

After Kaici distributes 2 medals to the target user, the corresponding base station or server deletes the stored demand information released by Kaici and stored response information.

If Kaici's mobile phone terminal does not receive any reply within 3 days, the corresponding base station or server deletes the stored demand information released by Kaici.

If Kaici obtains the reply but does not distribute medals to some target users who reply, next time when the corresponding base station or server receives demand information released by Kaici, the base station or server rejects the request and does not release the demand information.

An embodiment of the present invention further provides a paid interaction system for precise search, which can implement the paid interaction method for precise search in the foregoing embodiments correspondingly.

Referring to FIG. 2, FIG. 2 is a schematic structural diagram of a paid interaction system for precise search according to an embodiment of the present invention. The paid interaction system for precise search includes:

a receiving module 11, configured to receive demand information released by a first user terminal, where the demand information includes: a subject, a keyword, a main body, and a quantity of medals for rewarding.

In the embodiment of the present invention, the keyword is selected by a user autonomously, and the medals need to be purchased with money.

The system further includes a sending module 12, configured to send the demand information to all user terminals that customize the keyword, where the user terminals that customize the keyword are second user terminals.

The receiving module 11 is further configured to receive response information from at least one of the second user terminals, where the response information is reply information sent by the second user terminal to the first user terminal.

In the embodiment of the present invention, the reply information sent by the second user terminal to the first user terminal refers to information about a reply made by a user of the second user terminal according to the demand released by a user of the first user terminal.

The receiving module 11 is further configured to receive request information of the first user terminal for granting the medals to the second user terminal, where the request information for granting the medals includes the quantity of the medals.

The system further includes: an adding module 13, configured to add the medals to the selected second user terminal according to the request information for granting the medals; and

a deletion module 14, configured to delete the demand information and the response information.

In the embodiment of the present invention, the receiving module 11 may be a wireless receiver, and the sending module 12 may be a wireless transmitter. The wireless receiver and the wireless transmitter may be controllers or chips integrated with antennas, and can implement one or more of a WIFI transmission protocol, Bluetooth transmission protocol, Zigbee transmission protocol, or radio frequency (RF) transmission protocol. The adding module 13 and the deletion module 14 may be independent controllers or processors, or may share one controller, processor or chip.

In the embodiment of the present invention, for ease of clear presentation of the interaction process, the expressions of “demand information released by the first user terminal” and “response information of the second user terminal” are used in the embodiment of the present invention. However, in the embodiment of the present invention, the first user terminal is not restricted to be the carrier that releases the demand information, and the second user terminal is not restricted to be the carrier of the reply information. In the embodiment of the present invention, the first user terminal may also serve as the carrier of the reply information, and the second user terminal may also serve as the carrier that releases the demand information.

In the embodiment of the present invention, after the interaction is finished, the released demand information and the response information are deleted automatically, to reduce redundant information, thereby improving a data processing speed, and further improving search efficiency. In the embodiment of the present invention, the demand information is only sent to user terminals that customize the same keyword, to release the demand information precisely, so that demands of users can match each other, and interaction efficiency is improved.

In a preferred embodiment, the paid interaction system for precise search further includes:

a rejection module 15, configured to reject demand information released next time by the first user terminal if the request information of the first user terminal for granting the medals to the second user terminal is not received within specific duration after the receipt of the response information from the at least one of the second user terminals.

In the embodiment of the present invention, the rejection module 15 may be a wireless receiver. The wireless receiver may be a controller or chip integrated with an antenna, and can implement one or more of a WIFI transmission protocol, Bluetooth transmission protocol, Zigbee transmission protocol, or RF transmission protocol.

In the embodiment of the present invention, for a user who gets the reply but does not grant medals to some repliers, the next release request of the user is rejected, which can reduce the data amount and improve data processing efficiency on the one hand, and on the other hand, can ensure that the present method is implemented successfully.

In a preferred embodiment, the demand information further includes:

release duration; and the demand information is deleted if no response information from at least one of the second user terminals is received within the release duration starting from the moment when the demand information is released.

In the embodiment of the present invention, demand information and response information that exceed the time limit are deleted, to reduce redundant information, thereby improving the data processing speed and improving the search efficiency.

An embodiment of the present invention further provides a non-transient computer readable storage medium. The non-transient computer readable storage medium includes a stored computer program, and when being run, the computer program controls a device where the non-transient computer readable storage medium is located to execute the paid interaction method for precise search described above.

An embodiment of the present invention further provides a terminal device, including a processor, a memory, and a computer program stored in the memory and configured to be executed by the processor, where the processor, when executing the computer program, implements the paid interaction method for precise search described above.

The descriptions above are preferred embodiments of the present invention, and it should be noted that for those of ordinary skill in the art, various improvements and modifications can be made without departing from the principles of the present invention. These improvements and modifications should also be regarded as falling into the protection scope of the present invention.

1. A paid interaction method for precise search, comprising:
receiving demand information released by a first user terminal, wherein the demand information comprises: a subject, a keyword, a main body, and a quantity of medals for rewarding;
sending the demand information to all user terminals that customize the keyword, wherein the user terminals that customize the keyword are second user terminals;
receiving response information from at least one of the second user terminals, wherein the response information is reply information sent by the second user terminal to the first user terminal;
receiving request information of the first user terminal for granting the medals to the second user terminal, wherein the request information for granting the medals comprises the quantity of the medals;
adding the medals to the selected second user terminal according to the request information for granting the medals; and
deleting the demand information and the response information.

2. The paid interaction method for precise search according to claim 1, further comprising:
rejecting demand information released next time by the first user terminal if the request information of the first user terminal for granting the medals to the second user terminal is not received within specific duration after the receipt of the response information from the at least one of the second user terminals.

3. The paid interaction method for precise search according to claim 1, wherein the demand information further comprises:
release duration; and the demand information is deleted if no response information from at least one of the second user terminals is received within the release duration starting from the moment when the demand information is released.

4. The paid interaction method for precise search according to claim 2, wherein the demand information further comprises:
release duration; and the demand information is deleted if no response information from at least one of the second user terminals is received within the release duration starting from the moment when the demand information is released.

5. The paid interaction method for precise search according to claim 3, wherein while the demand information released by the first user terminal is received, the method further comprises:
receiving screening information sent by the first user terminal; and
screening user terminals that match the screening information after receiving the screening information sent by the first user terminal, wherein the screening information comprises a push region.

6. The paid interaction method for precise search according to claim 4, wherein while the demand information released by the first user terminal is received, the method further comprises:
receiving screening information sent by the first user terminal; and
screening user terminals that match the screening information after receiving the screening information sent by the first user terminal, wherein the screening information comprises a push region.

7. A paid interaction system for precise search, comprising:
a receiving module, configured to receive demand information released by a first user terminal, wherein the demand information comprises: a subject, a keyword, a main body, and a quantity of medals for rewarding;
a sending module, configured to send the demand information to all user terminals that customize the keyword, wherein the user terminals that customize the keyword are second user terminals;
the receiving module being further configured to receive response information from at least one of the second user terminals, wherein the response information is reply information sent by the second user terminal to the first user terminal;
the receiving module being further configured to receive request information of the first user terminal for granting the medals to the second user terminal, wherein the request information for granting the medals comprises the quantity of the medals;
an adding module, configured to add the medals to the selected second user terminal according to the request information for granting the medals; and
a deletion module, configured to delete the demand information and the response information.

8. The paid interaction system for precise search according to claim 7, further comprising:
a rejection module, configured to reject demand information released next time by the first user terminal if the request information of the first user terminal for granting the medals to the second user terminal is not received within specific duration after the receipt of the response information from the at least one of the second user terminals.

9. The paid interaction system for precise search according to claim 8, wherein the demand information further comprises:
release duration; and the demand information is deleted if no response information from at least one of the second user terminals is received within the release duration starting from the moment when the demand information is released.

10. A non-transient computer readable storage medium, wherein the non-transient computer readable storage medium comprises a stored computer program, and when being run, the computer program controls a device where the non-transient computer readable storage medium is located to execute the paid interaction method for precise search according to claim 1.

11. A non-transient computer readable storage medium, wherein the non-transient computer readable storage medium comprises a stored computer program, and when being run, the computer program controls a device where the non-transient computer readable storage medium is located to execute the paid interaction method for precise search according to claim 2.

12. A non-transient computer readable storage medium, wherein the non-transient computer readable storage medium comprises a stored computer program, and when being run, the computer program controls a device where the non-transient computer readable storage medium is located to execute the paid interaction method for precise search according to claim 3.

13. A non-transient computer readable storage medium, wherein the non-transient computer readable storage medium comprises a stored computer program, and when being run, the computer program controls a device where the non-transient computer readable storage medium is located to execute the paid interaction method for precise search according to claim 4.

14. A non-transient computer readable storage medium, wherein the non-transient computer readable storage medium comprises a stored computer program, and when being run, the computer program controls a device where the non-transient computer readable storage medium is located to execute the paid interaction method for precise search according to claim 5.

15. A terminal, comprising a processor, a memory, and a computer program stored in the memory and configured to be executed by the processor, wherein the processor, when executing the computer program, implements the paid interaction method for precise search according to claim 1.

16. A terminal, comprising a processor, a memory, and a computer program stored in the memory and configured to be executed by the processor, wherein the processor, when executing the computer program, implements the paid interaction method for precise search according to claim 2.

17. A terminal, comprising a processor, a memory, and a computer program stored in the memory and configured to be executed by the processor, wherein the processor, when executing the computer program, implements the paid interaction method for precise search according to claim 3.

18. A terminal, comprising a processor, a memory, and a computer program stored in the memory and configured to be executed by the processor, wherein the processor, when executing the computer program, implements the paid interaction method for precise search according to claim 4.

19. A terminal, comprising a processor, a memory, and a computer program stored in the memory and configured to be executed by the processor, wherein the processor, when executing the computer program, implements the paid interaction method for precise search according to claim 5.

20. A terminal, comprising a processor, a memory, and a computer program stored in the memory and configured to be executed by the processor, wherein the processor, when executing the computer program, implements the paid interaction method for precise search according to claim 6.
